(19) United States
(12) Patent Application Publication
(10) Pub. No.: US 2021/0136009 A1
(43) Pub. Date: May 6, 2021

(54) INFORMATION PROCESSING APPARATUS, INFORMATION PROCESSING SYSTEM, AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/837,086

(22) Filed: Apr. 1, 2020

(30) Foreign Application Priority Data
Oct. 30, 2019 (JP) 2019-197889

(51) Int. Cl. H04L 12/58; G06F 3/0486

(52) U.S. Cl. CPC H04L 51/04; G06F 2203/04803; H04L 51/16; G06F 3/0486

(57) ABSTRACT

An information processing apparatus includes a processor configured to set a user account of a speaker belonging to a chat group, cause a display device to display a display region for sharing content of a conversation held between plural speakers belonging to the chat group, receive at least a part of the conversation held between the plural speakers who have already joined the chat group before the speaker having the user account joins the chat group, and display the at least a part of the conversation in the display region for the user account in an inserted manner.

### CROSS-REFERENCE TO RELATED APPLICATIONS

This application is based on and claims priority under 35 USC 119 from Japanese Patent Application No. 2019-197889 filed Oct. 30, 2019.

### BACKGROUND

### (i) Technical Field

The present disclosure relates to an information processing apparatus, an information processing system, and a non-transitory computer readable medium.

### (ii) Related Art

A conversation may be held between plural speakers belonging to a chat group.

Japanese Unexamined Patent Application Publication No. 2005-316982 describes a chat apparatus that sends to a chat partner a first character string which has been input and first control information which is added in the case of a chat change, that analyzes information received from the chat partner, and that performs a chat change operation in a case where the information includes second control information indicating a chat change.

Japanese Unexamined Patent Application Publication No. 2000-207304 describes an interactive communication apparatus capable of making a visual expression by using a character or the like.

### SUMMARY

Aspects of non-limiting embodiments of the present disclosure relate to providing at least a part of a past conversation held between plural speakers to a user who is not a participant of the past conversation.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing apparatus including a processor configured to set a user account of a speaker belonging to a chat group, cause a display device to display a display region for sharing content of a conversation held between plural speakers belonging to the chat group, receive at least a part of the conversation held between the plural speakers who have already joined the chat group before the speaker having the user account joins the chat group, and display the at least a part of the conversation in the display region for the user account in an inserted manner.

### BRIEF DESCRIPTION OF THE DRAWINGS

An exemplary embodiment of the present disclosure will be described in detail based on the following figures, wherein:

FIG. 1 is a block diagram illustrating the configuration of an information processing system according to the exemplary embodiment;

FIG. 2 is a block diagram illustrating the configuration of an SNS server according to the exemplary embodiment;

FIG. 3 is a block diagram illustrating the configuration of a terminal apparatus according to the exemplary embodiment;

FIG. 4 is a diagram illustrating a screen for a user A;

FIG. 5 is a diagram illustrating a screen for a user D;

FIG. 6 is a diagram illustrating a screen for the user A;

FIG. 7 is a diagram illustrating a confirmation screen;

FIG. 8 is a diagram illustrating a screen for the user D;

FIG. 9 is a diagram illustrating a screen for the user D;

FIG. 10 is a diagram illustrating a screen for the user D;

FIG. 11 is a diagram illustrating a screen for the user D;

FIG. 12 is a diagram illustrating a screen for the user D;

FIG. 13 is a diagram illustrating a screen for the user A;

FIG. 14 is a diagram illustrating a screen for the user D;

FIG. 15 is a diagram illustrating a screen for a user B;

FIG. 16 is a diagram illustrating a screen for the user A;

FIG. 17 is a diagram illustrating a screen for the user A;

FIG. 18 is a diagram illustrating a screen for the user A;

FIG. 19 is a diagram illustrating a screen for the user A;

FIG. 20 is a diagram illustrating a screen for the user B; and

FIG. 21 is a diagram illustrating a screen for the user B.

### DETAILED DESCRIPTION

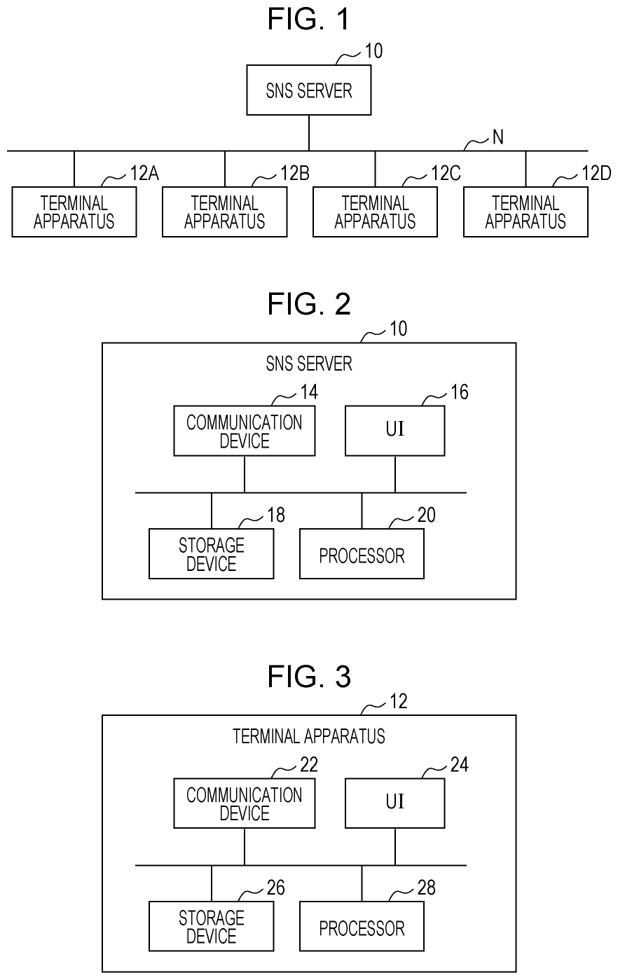

An information processing system according to an exemplary embodiment will be described with reference to FIG. 1. FIG. 1 illustrates an example of the configuration of the information processing system according to the exemplary embodiment.

The information processing system according to the exemplary embodiment includes, as an example, an SNS server 10 and plural terminal apparatuses. In the example illustrated in FIG. 1, the information processing system includes terminal apparatuses 12A, 12B, 12C, and 12D. The number of terminal apparatuses illustrated in FIG. 1 is merely an example, and the number is not limited as long as plural terminal apparatuses are included in the information processing system. Hereinafter, the terminal apparatuses 12A, 12B, 12C, and 12D will be referred to as “terminal apparatuses 12” when it is not necessary to distinguish them from each other. The information processing system may include an apparatus other than the terminal apparatuses (for example, a server or the like).

The SNS server 10 and each terminal apparatus 12 have a function of communicating with another apparatus. The communication may be wired communication using a cable or may be wireless communication. That is, each apparatus may be physically connected to another apparatus or the like by a cable and may send information to or receive information from the other apparatus, or may send information to or receive information from the other apparatus through wireless communication. As wireless communication, near field wireless communication, Wi-Fi (registered trademark), or the like is used, for example. Wireless communication of another standard may be used. Near field wireless communication is communication using, for example, Bluetooth (registered trademark), radio frequency identifier (RFID), near field communication (NFC), or the like. Each apparatus may communicate with another apparatus through a communication path, such as a local area network (LAN) or the Internet. In the example illustrated in FIG. 1, the SNS server 10 and each terminal apparatus 12 are capable of communicating with another apparatus through a communication path N. The communication path N is, for example, the Internet.

The SNS server 10 is a server that provides a social networking service (SNS). An SNS is a service of supporting or promoting information communication between participants of the SNS to support or promote establishment of a relationship between a participant and another participant. There may be an SNS in which the participation therein is not permitted without invitation of an existing participant. Examples of an SNS include Facebook (registered trademark), LINE (registered trademark), Twitter (registered trademark), and LinkedIn (registered trademark).

Information that is sent and received in an SNS includes, for example, data of a character string, such as a message or a comment, image data, audio data, or any selective combination thereof.

The SNS server 10 stores and manages user account information of participants, who are members registered in an SNS. The user account information is information for logging in to and using the SNS and is, for example, information including an SNS ID and a password. For example, a participant having user account information (i.e., a participant assigned the user account information) sends the user account information to the SNS server 10 and logs in to the SNS, and is then permitted to use the SNS. A participant who participates in the SNS and sends or receives information corresponds to an example of a speaker.

The SNS server 10 may store and manage information indicating the relationships between participants. The information indicating the relationships between participants is, for example, information indicating the degree of trust between participants in the SNS, information indicating the type of relationship (for example, friends) between participants, or information indicating both.

The terminal apparatus 12 is, for example, a personal computer (PC), a tablet PC, a smartphone, a mobile phone, or the like. The terminal apparatus 12 corresponds to an example of an information processing apparatus. The terminal apparatus 12 is used by a user to use the SNS. For example, when user account information for the SNS is set in the terminal apparatus 12, the user account information is output to the SNS server 10, and the user logs in to the SNS.

In the exemplary embodiment, as an example, the terminal apparatus 12A is used by a user A, the terminal apparatus 12B is used by a user B, the terminal apparatus 12C is used by a user C, and the terminal apparatus 12D is used by a user D.

Pieces of user account information of the respective users A, B, C, and D are stored in and managed by the SNS server 10. That is, the users A, B, C, and D are SNS participants registered in the SNS provided by the SNS server 10.

For example, the user A operates the terminal apparatus 12A to log in to the SNS, thereby being capable of using the SNS. The same applies to the users B, C, and D. Alternatively, plural users may operate a single terminal apparatus 12 to log in to the SNS and may operate the single terminal apparatus 12 to post information to the SNS.

User account information of an automatic answering partner, such as a chatbot, may be managed by the SNS server 10, and the automatic answering partner may be an SNS participant. For example, the automatic answering partner is configured to function as an answering assistant that responds to an inquiry from a user, receive and analyze an utterance of the user in the SNS, generate an answer or the like to the utterance, and notify the user of the answer in the SNS. The automatic answering partner is implemented by, for example, executing a program. The program is stored in, for example, the SNS server 10, another server, or the terminal apparatus 12. The automatic answering partner may be an automatic answering artificial intelligence (AI) based on AI. Any algorithm may be used for the AI.

In the exemplary embodiment, a chat group is formed in the SNS. The chat group is a group in which information, such as messages and images, is sent and received only between plural participants belonging to the chat group. Information posted to the chat group is sent to the participants belonging to the chat group and is not sent to the other participants of the SNS who do not belong to the chat group. That is, a chat is performed only between the participants belonging to the chat group. For example, at least a part of content of a conversation held between plural participants belonging to the chat group is sent to another participant belonging to the chat group. The conversation includes information sent and received in the chat group. A participant of the SNS may belong to plural chat groups.

Hereinafter, the hardware configuration of the SNS server 10 will be described with reference to FIG. 2. FIG. 2 illustrates an example of the hardware configuration of the SNS server 10.

The SNS serve 10 includes, for example, a communication device 14, a user interface (UI) 16, a storage device 18, and a processor 20.

The communication device 14 is a communication interface and has a function of sending information to another apparatus and a function of receiving information sent from another apparatus. The communication device 14 may have a wireless communication function or a wired communication function. The communication device 14 may communicate with another apparatus by using, for example, near field wireless communication or via a communication path, such as a LAN or the Internet.

The UI 16 is a user interface and includes a display device and an operation device. The display device is a liquid crystal display, an electroluminescence (EL) display, or the like. The operation device is a keyboard, an input key, an operation panel, or the like. The UI 16 may be a UI, such as a touch screen serving as both a display device and an operation device. The UI 16 may include a microphone or a speaker that outputs sound. The UI 16 need not necessarily be included in the SNS server 10.

The storage device 18 is a device including one or plural storage regions for storing various pieces of information. The storage device 18 is, for example, a hard disk drive, various types of memories (for example, a RAM, a DRAM, a ROM, or the like), another type of storage device (for example, an optical disc or the like), or any selective combination thereof. One or plural storage devices 18 are included in the SNS server 10.

The storage device 18 stores user account information of participants registered in the SNS. In addition, the storage device 18 may store information indicating the relationships between the participants.

The processor 20 is configured to control the operations of the individual components of the SNS server 10. For example, the processor 20 may communicate with each apparatus by using the communication device 14, may cause the display device of the UI 16 to display information, may receive information input via the UI 16, may cause the storage device 18 to store information, or may read out information from the storage device 18. The processor 20 may include a memory.

The processor 20 is configured to provide the SNS. For example, the processor 20 sends information, such as a message or an image, posted in the SNS to a destination.

The processor 20 is configured to manage a chat group. Managing a chat group includes forming a chat group, dismissing a chat group, allowing a new participant to belong to a chat group, allowing a participant to leave a chat group, and the like.

For example, the processor 20 forms a chat group in response to receipt of a request for forming the chat group from a participant of the SNS. In a case where a participant not belonging to a chat group wants to belong to the chat group and in a case where another participant belonging to the chat group gives approval, the processor 20 may allow the participant not belonging to the chat group to belong to the chat group. The processor 20 may allow a participant belonging to a chat group to leave the chat group in response to a leaving request from the participant.

The processor 20 causes the storage device 18 to store management information including group identification information for identifying a chat group and user identification information for identifying a participant belonging to the chat group that are associated with each other. Referring to the management information makes it possible to specify a participant belonging to the chat group. The group identification information is information indicating a group ID, a group name, or the like. The user identification information may be user account information for the SNS, information used to identify a participant in the SNS (for example, a user ID, a name, a nickname, a handle, or the like), or other information. In addition, the processor 20 causes the storage device 18 to store, in association with the above-described user identification information, time information indicating the time (for example, the date and time) at which a participant belonging to a chat group started belonging the chat group. The time information is included in the above-described management information. Referring to the time information makes it possible to specify the time at which the participant started belonging the chat group. The processor 20 may cause the storage device 18 to store, in association with the user identification information, time information indicating the time at which a participant left a chat group.

For example, in a case where the user A belonging to a chat group operates the terminal apparatus 12A of the user A to post information, such as a message or an image, to the chat group, the posted information is sent from the terminal apparatus 12A to the SNS server 10. The processor 20 of the SNS server 10 receives the posted information and sends the posted information to the terminal apparatus 12 of another user belonging to the chat group. For example, the posted information, the user identification information of the user A, and group identification information are sent from the terminal apparatus 12A to the SNS server 10, and the processor 20 specifies the user identification information of a user other than the user A associated with the group identification information in the above-described management information. The processor 20 sends the information posted by the user A to the terminal apparatus 12 of the user indicated by the specified user identification information. The same applies to the users B, C, and D.

The processor 20 may be configured to manage a history of posting to the SNS. For example, the processor 20 may manage, for each participant, a history of information posted to the SNS by the participant. Alternatively, the processor 20 may manage, for each chat group, a history of information sent and received in the chat group. History information indicating the history is stored in the storage device 18.

A program for implementing an automatic answering partner may be stored in the storage device 18 and may be executed by the processor 20. Accordingly, posting to the SNS by the automatic answering partner is realized by the SNS server 10.

Hereinafter, the hardware configuration of the terminal apparatus 12 will be described with reference to FIG. 3. FIG. 3 illustrates an example of the hardware configuration of the terminal apparatus 12.

The terminal apparatus 12 includes, for example, a communication device 22, a UI 24, a storage device 26, and a processor 28.

The communication device 22 is a communication interface and has a function of sending information to another apparatus and a function of receiving information sent from another apparatus. The communication device 22 may have a wireless communication function or a wired communication function. The communication device 22 may communicate with another apparatus by using, for example, near field wireless communication or via a communication path, such as a LAN or the Internet.

The UI 24 is a user interface and includes a display device and an operation device. The display device is a liquid crystal display, an EL display, or the like. The operation device is a keyboard, an input key, an operation panel, or the like. The UI 24 may be a UI, such as a touch screen serving as both a display device and an operation device. The UI 24 may include a microphone or a speaker that outputs sound.

The storage device 26 is a device including one or plural storage regions for storing various pieces of information. The storage device 26 is, for example, a hard disk drive, various types of memories (for example, a RAM, a DRAM, a ROM, or the like), another type of storage device (for example, an optical disc or the like), or any selective combination thereof. One or plural storage devices 26 are included in the terminal apparatus 12.

For example, the storage device 26 stores an SNS application program for using the SNS provided by the SNS server 10. Execution of the SNS application program by the processor 28 enables the terminal apparatus 12 to use the SNS.

The processor 28 is configured to control the operations of the individual components of the terminal apparatus 12. For example, the processor 28 may communicate with each apparatus by using the communication device 22, may cause the display device of the UI 24 to display information, may receive information input via the UI 24, may cause the storage device 26 to store information, or may read out information from the storage device 26. The processor 28 may include a memory.

The processor 28 is configured to set user account information for the SNS in response to a user instruction and log in to the SNS by using the user account information. After login, the processor 28 posts information, such as a message or an image, to the SNS in response to a user instruction. In a case where a chat group has been formed, the processor 28 may post information, such as a message or an image, to the chat group in response to a user instruction.

The processor 28 is configured to cause the display device of the UI 24 to display a display region for displaying information posted to the SNS. For example, in a case where a chat group has been formed, the display region is used to share the content of a conversation in the SNS held between plural participants belonging to the chat group.

Hereinafter, a process performed by the information processing system according to the exemplary embodiment will be described in detail by using specific examples.

As an example, it is assumed that the users A, B, C, and D are participants registered in the SNS and have logged in to the SNS server 10. It is also assumed that a chat group α to which the users A, B, and C belong has been formed, and that the user D belongs to the chat group α later. Hereinafter, it is assumed that, for convenience of description, messages are sent and received in the chat group α. Of course, data, such as image data or music data, may be sent and received.

For example, when the user A operates the terminal apparatus 12A to request the SNS server 10 to form the chat group α in the SNS, the processor 20 of the SNS server 10 forms the chat group α to which the user A belongs in the SNS. When the user B operates the terminal apparatus 12B to request the SNS server 10 to allow the user B to belong to the chat group α, the processor 20 of the SNS server 10 allows the user B to belong to the chat group α. The same applies to the users C and D. In addition, the same applies to a case where the user B, C, or D requests formation of a chat group.

In a case where a user requests belonging to a chat group and in a case where a user (for example, the user A) who has requested formation of the chat group or one or plural users belonging to the chat group gives approval, the processor 20 of the SNS server 10 may allow the user who requests belonging to the chat group to belong to the chat group.

As another example, when the user A requests the SNS server 10 to form a chat group α to which the users A, B, and C belong, the SNS server 10 may form the chat group α to which the users A, B, and C belong in response to the request. When the user A requests the SNS server 10 to allow the user D to belong to the chat group α, the SNS server 10 may allow the user D to belong to the chat group α in response to the request.

When a user having a right to form a chat group requests the SNS server 10 to form a chat group, the chat group may be formed.

The processor 20 of the SNS server 10 manages the chat group α. Specifically, the processor 20 causes the storage device 18 to store management information including group identification information of the chat group α and user identification information of a user belonging to the chat group α that are associated with each other. For example, in a case where the users A, B, and C belong to the chat group α, the group identification information of the chat group α and the pieces of user identification information of the users A, B, and C are included in the management information in association with each other. When the user D newly starts belonging to the chat group α, the group identification information of the chat group α and the pieces of user identification information of the users A, B, C, and D are included in the management information in association with each other. In addition, pieces of time information indicating the times (for example, the dates and times) at which the respective users A, B, C, and D started belonging to the chat group α are included in the management information in association with the pieces of user identification information of the users A, B, C, and D.

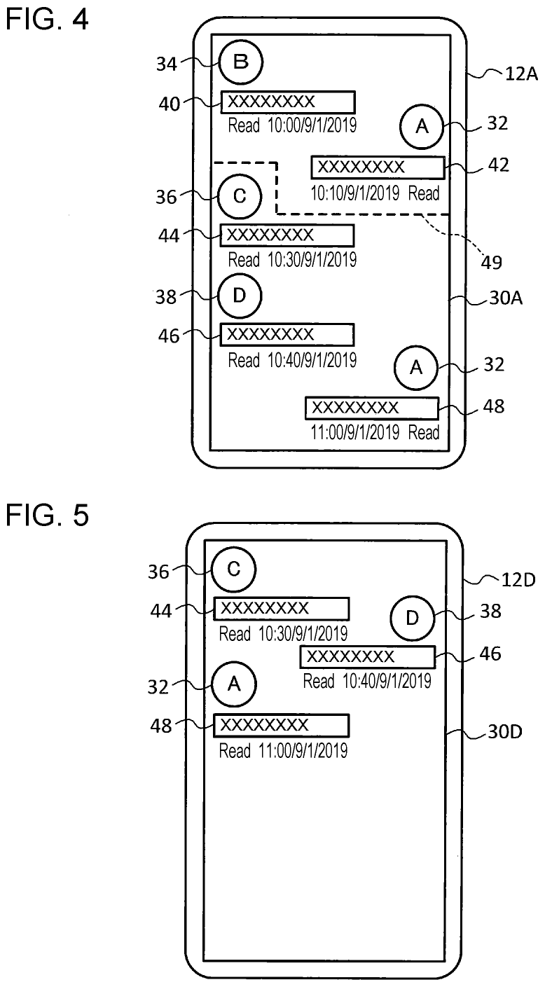

FIG. 4 illustrates an example of a screen displayed when information is sent and received between participants belonging to a chat group. A screen 30A illustrated in FIG. 4 is a chat screen displayed on the UI 24 of the terminal apparatus 12A used by the user A. The processor 28 of the terminal apparatus 12A causes the display device of the UI 24 to display the screen 30A. The screen 30A is an example of a display region that allows plural users belonging to the chat group α to share the content of a conversation held between the users. On the screen 30A, a message posted by the user A to the chat group α in the SNS, and messages posted by the users B, C, and D, who are the other users belonging to the chat group α, to the chat group α in the SNS are displayed. Here, as an example, the conversation in the chat group α is a chat-style conversation. That is, the style of a conversation held in the chat group α is a style in which the individual users belonging to the chat group α make utterances to have a conversation.

For example, when the user A operates the terminal apparatus 12A to provide an instruction to start the SNS application program, the processor 28 of the terminal apparatus 12A starts the SNS application program. Accordingly, the processor 28 causes the display device of the UI 24 of the terminal apparatus 12A to display an SNS screen. When the user A requests formation of a chat group α on the screen, the SNS server 10 forms the chat group α, and the screen 30A for the chat group α is displayed on the display device of the UI 24 of the terminal apparatus 12A. Alternatively, the chat group α may be formed in advance. In this case, the screen 30A for the chat group α is displayed on the display device of the UI 24 of the terminal apparatus 12A when the user A provides an instruction to display the screen 30A.

The processor 28 of the terminal apparatus 12A displays messages of individual users posted to the chat group α on the screen 30A. For example, the processor 28 of the terminal apparatus 12A displays a message posted to the chat group α by the user A using the terminal apparatus 12A on the screen 30A. The processor 28 receives, via the SNS server 10, messages of other users posted to the chat group α, and displays the received messages on the screen 30A. For example, the processor 28 of the terminal apparatus 12A displays the messages of the individual users posted to the chat group α on the screen 30A in chronological order in accordance with the dates and times at which the messages were posted. When the conversation proceeds on the screen 30A, the processor 28 scrolls the screen 30A to display the latest message on the screen 30A.

The processor 28 of the terminal apparatus 12A causes the screen 30A to display images associated with the individual users belonging to the chat group α. An image associated with a user is an example of user identification information for identifying the user and corresponds to an example of speaker identification information. For example, an image 32 is an image associated with the user A, an image 34 is an image associated with the user B, an image 36 is an image associated with the user C, and an image 38 is an image associated with the user D. Instead of or in addition to an image, a character string for identifying a user (for example, a name, an ID, a handle, a nickname, or the like) may be displayed on the screen 30A. The character string also corresponds to an example of speaker identification information.

For example, on the screen 30A displayed on the terminal apparatus 12A used by the user A, a message posted by the user A is displayed in a right-side region, and messages posted by the users B, C, and D are displayed in a left-side region. This display style is merely an example, and another display style may be adopted. For example, the messages posted by the individual users may be displayed separately on upper and lower regions, or may be displayed in the same region.

Also in the terminal apparatus 12B used by the user B, the terminal apparatus 12C used by the user C, and the terminal apparatus 12D used by the user D, a screen similar to the screen 30A is displayed. A message posted by the user is displayed in a right-side region, and messages posted by the other users are displayed in a left-side region.

Hereinafter, the screen 30A for the chat group α displayed on the display device of the UI 24 of the terminal apparatus 12A of the user A may be referred to as “the screen 30A of the user A”. The same applies to the screens for the chat group α displayed on the terminal apparatuses 12B, 12C, and 12D.

In the example illustrated in FIG. 4, a message 40 of the user B, a message 42 of the user A, a message 44 of the user C, a message 46 of the user D, and a message 48 of the user A are posted in this order. These messages are sent to the terminal apparatuses 12 of the individual users belonging to the chat group α via the SNS server 10. For example, when the user A operates the terminal apparatus 12A to post the message 48 to the chat group α, the message 48, the user identification information of the user A who has posted the message 48, and the group identification information indicating the chat group α are sent from the terminal apparatus 12A to the SNS server 10. The processor 20 of the SNS server 10 refers to the management information stored in the storage device 18 to specify the pieces of user identification information of the users other than the user A associated with the group identification information. Accordingly, the users B, C, and D belonging to the chat group α indicated by the group identification information are specified. The processor 20 of the SNS server 10 sends the message 48 to the terminal apparatuses 12 of the specified users B, C, and D. The message 48 is displayed on the screen for the chat group α in each of the terminal apparatuses 12 of the users B, C, and D.

The messages 40 to 48 are displayed on the screen 30A from the top to bottom of the screen 30A in chronological order in accordance with the dates and times at which the messages were posted. Among the messages 40 to 48, the message 40 is the oldest message, and the message 48 is the latest message. In a case where image data, music data, or the like is posted, a thumbnail image or the like associated with the image data or music data is displayed on the screen 30A.

On the screen 30A for the user A, messages posted after the user A has started belonging to the chat group α are displayed. In the example illustrated in FIG. 4, the user A belongs to the chat group α at a time point before the time point at which the user A posts the message 42. Thus, the message 40 of the user B, posted before the time point at which the message 42 is posted, is also displayed on the screen 30A. Scrolling of the screen 30A enables the screen 30A to display a message posted before the time point at which the message 40 is posted and after the user A has started belonging to the chat group α.

Information indicating the date and time at which a message was posted may be displayed in association with the message. For example, the message 40 is posted at 10:00 on Sep. 1, 2019, and a character string indicating the date and time is displayed on the screen 30A in association with the message 40. For example, the character string indicating the date and time is displayed around the display position of the message 40 (for example, below the message 40). The same applies to the other messages. In addition, a mark indicating that a message has been read by another user (for example, a “read” mark) may be displayed in association with the message.

Here, as an example, it is assumed that the user D starts belonging to the chat group α at the time indicated by a broken line 49, which is a virtual line. In other words, it is assumed that the user D starts belonging to the chat group α at a time point after the message 42 is posted and before the message 44 is posted.

FIG. 5 illustrates an example of a screen 30D for the user D. The screen 30D for the user D is a screen for the chat group α and is a screen displaying messages posted to the chat group α. The user D starts belonging to the chat group α at the time point indicated by the broken line 49, and thus the messages 44, 46, and 48, posted after the time point at which the user D starts belonging to the chat group α, are displayed on the screen 30D. The messages 40 and 42, posted before the time point at which the user D starts belonging to the chat group α, have not been sent to the terminal apparatus 12D of the user D and are thus not displayed on the screen 30D. On the screen 30D for the user D, a message posted by the user D is displayed in a right-side region, and messages posted by other users are displayed in a left-side region.

On a screen 30B for the user B, a message posted after the user B has started belonging to the chat group α is displayed. On a screen 30C for the user C, a message posted after the user C has started belonging to the chat group α is displayed. The screen 30B for the user B is a screen for the chat group α displayed on the terminal apparatus 12B of the user B and is a screen displaying a message posted to the chat group α. The screen 30C for the user C is a screen for the chat group α displayed on the terminal apparatus 12C of the user C and is a screen displaying a message posted to the chat group α.

Each user belonging to the chat group α is capable of sending a message that has already been posted to the chat group α to another user belonging to the chat group α via the SNS. The message that is sent is an example of at least a part of a conversation held between plural speakers. For example, each user is capable of sending a message posted to the chat group α after the user has started belonging to the chat group α to another user belonging to the chat group α via the SNS. In addition, each user may be capable of further sending a message received thereby to another user via the SNS. The message sent in this manner is displayed only on the screen for the user who is a destination of the message, and is not displayed on the screens for the users other than the destination user.

For example, when a user operates the terminal apparatus 12 to designate a target message to be sent that has already been posted to a chat group and a destination user, and to provide an instruction to send the target message to the destination user, the processor 28 of the terminal apparatus 12 sends to the SNS server 10 the target message, the user identification information of the destination user, and the group identification information of the chat group. The processor 20 of the SNS server 10 receives the target message, the user identification information, and the group identification information, and sends the target message to the terminal apparatus 12 of the user indicated by the user identification information via the SNS. The processor 28 of the terminal apparatus 12 of the destination user receives the target message from the SNS server 10 and displays the target message on a screen for the chat group.

The user identification information of the user who has posted the target message to the chat group, the user identification information of the source user who has provided the instruction to send the target message to the destination user, or both the pieces of user identification information may be sent from the terminal apparatus 12 of the source user to the SNS server 10, together with the target message, the user identification information of the destination user, and the group identification information. In the terminal apparatus 12 of the destination user, the target message is displayed on the screen for the destination user in association with the user identification information of the user who has posted the target message to the chat group, the user identification information of the source user, or both the pieces of user identification information. The user identification information associated with the target message may be designated by the source user or may be predetermined.

A user may send a message posted to a chat group by the user to another user belonging to the chat group, or may send a message posted to the chat group by someone other than the user to another user belonging to the chat group. A user may send a message posted to a chat group to the user. A user may be prohibited from sending a message posted to a chat group by someone other than the user to another user.

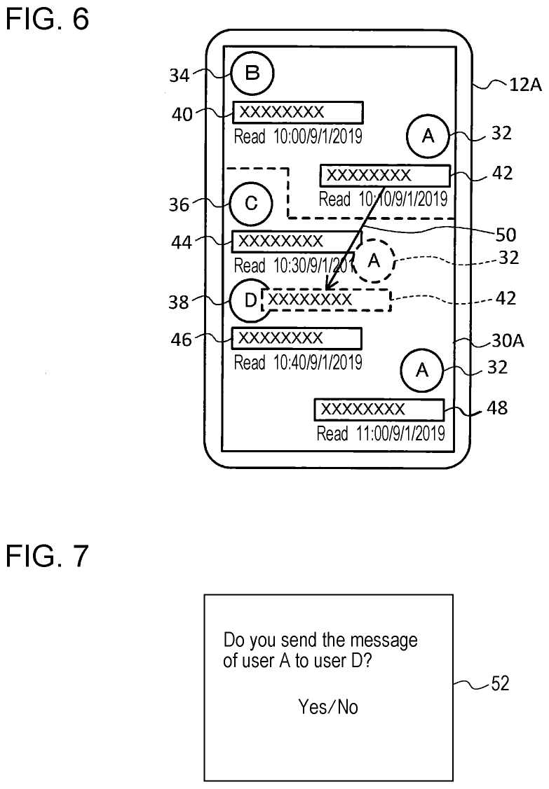

A specific operation will be described with reference to FIG. 6. FIG. 6 illustrates the screen 30A for the user A. For example, when the user A designates the message 42 on the screen 30A, moves the message 42 (i.e., an image representing the message 42) to the position of the image 38 of the user D as indicated by an arrow 50, and provides an instruction to send the message 42 with the message 42 being superimposed on the image 38, the message 42 is sent to the user D. That is, the processor 28 of the terminal apparatus 12A recognizes that the message 42 designated by the user A is a target message to be sent, and recognizes that the user D represented by the image 38 on which the message 42 is superimposed is a destination user. The processor 28 of the terminal apparatus 12A may recognize that the message 42 is a target message to be sent and that the user D is a destination user in a case where the message 42 is partially superimposed on the image 38, or may recognize that the message 42 is a target message to be sent and that the user D is a destination user in a case where the message 42 is superimposed on the entire image 38. The arrow 50 may or may not be displayed on the screen 30A. In a case where the message 42 is superimposed on the message 46 associated with the image 38 of the user D, the processor 28 of the terminal apparatus 12A may recognize that the message 42 is a target message to be sent and that the user D is a destination user.

For example, with a drag-and-drop operation using a touch operation, the message 42 is moved and an instruction to send the message 42 is provided. Specifically, the user A performs a touch operation on the screen 30A to move the message 42 to the position of the image 38 (i.e., to drag the message 42). When the touch operation ends with the message 42 being superimposed on the image 38, that is, when the user A moves his/her finger or the like off the message 42 on the screen 30A (i.e., when the user A drops the message 42), an instruction to send the message 42 is provided.

While the user A is moving the message 42, the processor 28 of the terminal apparatus 12A may or may not display the message 42 at the original position on the screen 30A. In addition, the image 32 of the user A who has posted the message 42 to the chat group α may or may not be moved together with the message 42.

The target message 42 to be sent and the destination user D may be designated by an operation other than a touch operation. For example, the target message 42 to be sent and the destination user D may be designated by using sound, or the target message 42 to be sent and the destination user D may be designated by operating a mouse connected to the terminal apparatus 12A.

In response to the instruction to send the message 42 to the user D provided by the user A, the processor 28 of the terminal apparatus 12A sends the message 42, the user identification information of the user D, and the group identification information of the chat group α to the SNS server 10. The processor 28 of the terminal apparatus 12A may send to the SNS server 10 the user identification information of the user A who has posted the message 42 to the chat group α, the user identification information of the user A as a sending source who has provided the instruction to send the message 42 to the destination user D, or both the pieces of user identification information, together with the message 42, the user identification information of the user D, and the group identification information of the chat group α. In the example illustrated in FIG. 6, the user A provides the instruction to send to the user D the message 42 that has been posted to the chat group α by the user A. Thus, the user identification information of the user who has posted the message 42 to the chat group α and the user identification information of the source user who has provided the instruction to send the message 42 to the destination user D are the user identification information of the user A.

In response to receipt of the message 42, the user identification information of the user D, and the group identification information of the chat group α from the terminal apparatus 12A, the processor 20 of the SNS server 10 sends the message 42 and the group identification information of the chat group α to the terminal apparatus 12D of the user D via the SNS.

In response to receipt of the message 42 and the group identification information of the chat group α from the SNS server 10, the processor 28 of the terminal apparatus 12D displays the message 42 on the screen 30D for the chat group α. In this way, in a case where the chat group α has been formed, a message posted to the chat group α can be sent to a specific user without the message being sent to all the users belonging to the chat group α. For example, a message posted to the chat group α before the user D starts belonging to the chat group α (i.e., a past message) is sent to the user D and displayed on the screen 30D for the user D. Of course, a message posted to the chat group α may be sent to all the users belonging to the chat group α.

In response to receipt of the user identification information of the user A who has posted the message 42 to the chat group α, the user identification information of the user A as a sending source who has provided the instruction to send the message 42 to the destination user D, or both the pieces of user identification information from the terminal apparatus 12A, the processor 20 of the SNS server 10 sends, to the terminal apparatus 12D of the user D via the SNS, the user identification information of the user A who has posted the message 42 to the chat group α, the user identification information of the user A as a sending source who has provided the instruction to send the message 42 to the destination user D, or both the pieces of user identification information.

In response to receipt of the user identification information of the user A who has posted the message 42 to the chat group α from the SNS server 10, the processor 28 of the terminal apparatus 12D displays the user identification information of the user A who has posted the message 42 to the chat group α on the screen 30D for the chat group α in association with the message 42. For example, the processor 28 of the terminal apparatus 12D displays the image 32 of the user A on the screen 30D in association with the message 42. The image 32 displayed at this time corresponds to an example of speaker identification information of the user A.

In response to receipt of the user identification information of the user A as a sending source who has provided the instruction to send the message 42 to the destination user D from the SNS server 10, the processor 28 of the terminal apparatus 12D displays the user identification information of the user A as a sending source on the screen 30D for the chat group α in association with the message 42. For example, the processor 28 of the terminal apparatus 12D displays the image 32 of the user A on the screen 30D in association with the message 42. The image 32 displayed at this time corresponds to an example of speaker identification information of the user A.

In response to receipt of the user identification information of the user A who has posted the message 42 to the chat group α and the user identification information of the user as a sending source A who has provided the instruction to send the message 42 to the destination user D from the SNS server 10, the processor 28 of the terminal apparatus 12D displays these pieces of user identification information on the screen 30D for the chat group α in association with the message 42. For example, the processor 28 of the terminal apparatus 12D displays the two images 32 on the screen 30D in association with the message 42.

The target message 42 is sent only to the user D designated as a destination user and is not sent to the users B and C belonging to the chat group α.

In a case where the user A has provided the instruction to send the message 42 to the user D, a confirmation screen may be displayed. FIG. 7 illustrates an example of the screen. A screen 52 is displayed on the display device of the UI 24 of the terminal apparatus 12A. On the screen 52, a message “Do you send the message of user A to user D?” is displayed. The message 42 is sent to the user D in response to pressing of a “Yes” button on the screen 52 by the user A. The message 42 is not sent in response to pressing of a “No” button on the screen 52 by the user A.

The sending of a target message may be reserved. For example, a source user designates a reservation time at which a target message is to be sent to a destination user and provides an instruction to send the message. Accordingly, the target message is sent to the destination user at the designated reservation time. For example, the terminal apparatus 12 of the source user sends the target message to the SNS server 10 at the reservation time, and the SNS server 10 sends the target message to the terminal apparatus 12 of the destination user. As another example, the terminal apparatus 12 of the source user may send the target message to the SNS server 10 in response to an instruction to send the message by the user, and the SNS server 10 may send the target message to the terminal apparatus 12 of the destination user at the reservation time.

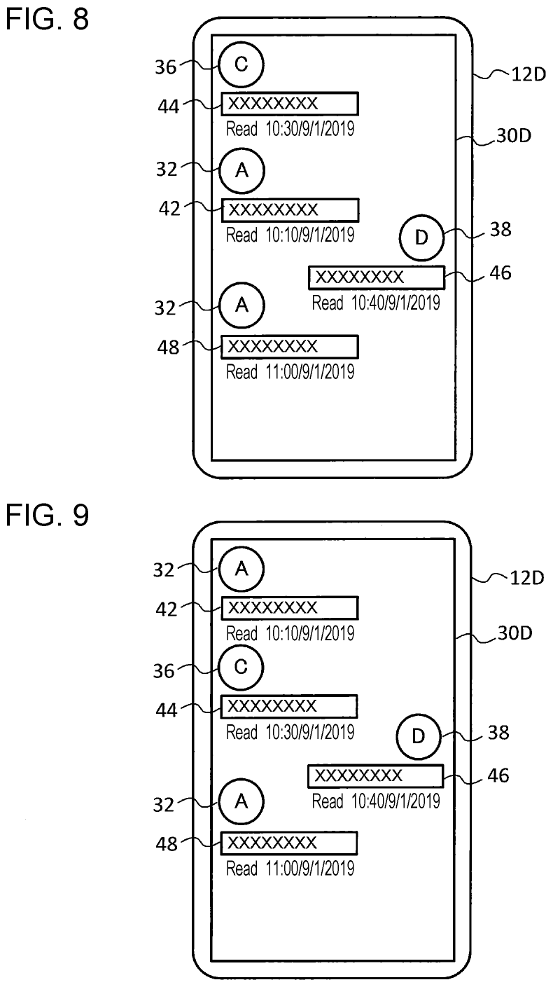

FIG. 8 illustrates the screen 30D after the message 42 has been sent to the user D. In response to receipt of the message 42 via the SNS, the processor 28 of the terminal apparatus 12D displays the message 42 on the screen 30D. On the screen 30D, individual messages are displayed in chronological order in accordance with the dates and times at which the messages were posted. The processor 28 of the terminal apparatus 12D displays, on the screen 30D, the message 42 at the position immediately before the message 46 of the user D posted last to the chat group α by the user D (i.e., the latest message of the user D). That is, the message 42 sent to the user D is displayed between the message 44 of the user C and the message 46 of the user D.

In a case where the message 46 of the user D has not been posted to the chat group α when the message 42 is sent to the user D, the processor 28 of the terminal apparatus 12D may display the message 42 on the screen 30D in chronological order in accordance with the dates and times at which the messages were posted, or may display the message 42 on the screen 30D at the last position in the chronological order.

In addition, the image 32 of the user A is displayed on the screen 30D in association with the message 42. The image 32 may be an image indicating that the user who has posted the message 42 to the chat group α is the user A or may be an image indicating that the user who has sent the message 42 to the destination user D is the user A.

Information indicating the date and time at which the message 42 was posted to the chat group α by the user A may be displayed in association with the message 42, or information indicating the date and time at which the message 42 was sent to the user D by the user A may be displayed in association with the message 42. In the example illustrated in FIG. 8, information indicating the date and time at which the message 42 was posted is displayed.

FIG. 9 illustrates another example of the screen 30D after the message 42 has been sent to the user D. In the example illustrated in FIG. 9, the processor 28 of the terminal apparatus 12D displays the message 42 sent to the user D and other messages on the screen 30D in chronological order in accordance with the dates and times at which the messages were posted. The message 42 sent to the user D is posted to the chat group α before the message 44 of the user C. Thus, the processor 28 of the terminal apparatus 12D displays, on the screen 30D, the message 42 at the position corresponding to a time point before the time point at which the message 44 is posted. For example, the message 42 is displayed above the message 44.

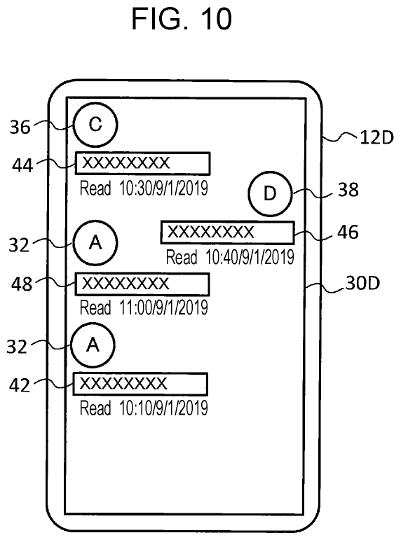

As still another example, the processor 28 of the terminal apparatus 12D may display the message 42 sent to the user D at the last position in the chronological order. That is, the processor 28 of the terminal apparatus 12D displays the message 42 as a message posted after the messages displayed in chronological order. For example, the message 48 of the user A is the latest message, and thus the message 42 is displayed, on the screen 30D, at the position corresponding to a time point after the time point at which the message 48 is posted, as illustrated in FIG. 10.

The position at which a target message to be sent is to be displayed on the screen for a destination user may be determined by the destination user or a source user. In the case of the example given above, the position at which the message 42 sent to the user D is to be displayed on the screen 30D for the user D may be determined by the destination user D or the source user A.

In a case where the source user A designates the position at which the message 42 is to be displayed, information indicating the position is sent from the terminal apparatus 12A to the terminal apparatus 12D via the SNS server 10. The processor 28 of the terminal apparatus 12D displays the message 42 at the position on the screen 30D.

In a case where the position at which a target message to be sent is to be displayed on the screen for a destination user is determined by the destination user, the target message may be displayed on a screen for the target message on the screen for the destination user. The screen for the target message is a screen different from a screen on which messages posted to the chat group are displayed in chronological order and is, for example, a screen dedicated to the target message. In a case where an operation is performed to move the target message from the screen for the target message to the screen on which messages posted to the chat group are displayed in chronological order, the target message is displayed on the screen on which messages posted to the chat group are displayed in chronological order.

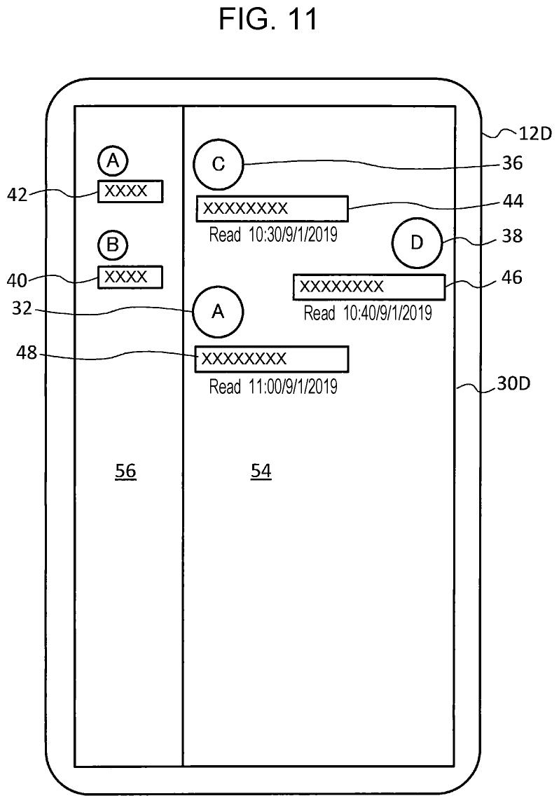

The screen for the target message will be described with reference to FIG. 11. FIG. 11 illustrates the screen 30D for the user D. The screen 30D includes a first screen 54 and a second screen 56 disposed next to the first screen 54. The first screen 54 is an example of a first display region. On the first screen 54, messages posted to the chat group α are displayed in chronological order. In the example illustrated in FIG. 11, the same messages as those illustrated in FIG. 5 are displayed on the first screen 54. The second screen 56 is a screen for a target message and is an example of a second display region.

The processor 28 of the terminal apparatus 12D of the user D displays a target message that has been sent to the user D on the second screen 56. In the example illustrated in FIG. 11, the message 40 of the user B and the message 42 of the user A have been sent to the user D, and the messages 40 and 42 are displayed on the second screen 56. For example, the messages 40 and 42 are displayed on the second screen 56 in the order in which the messages have been sent to the user D. In the example illustrated in FIG. 11, the message 42 of the user A is sent first to the user D, and then the message 40 of the user B is sent to the user D. When a message is newly sent to the user D, the message is displayed on the second screen 56.

The messages displayed on the second screen 56 may be temporarily displayed on the second screen 56. For example, when a predetermined time elapses from the time point at which the terminal apparatus 12D of the user D receives a target message, the processor 28 of the terminal apparatus 12D hides the message from the second screen 56 even if the user D does not provide an instruction to hide the message. In this case, the processor 28 of the terminal apparatus 12D may delete the message from the terminal apparatus 12D or may hide the message from the second screen 56 without deleting the message. Alternatively, the user D may delete or hide the message displayed on the second screen 56.

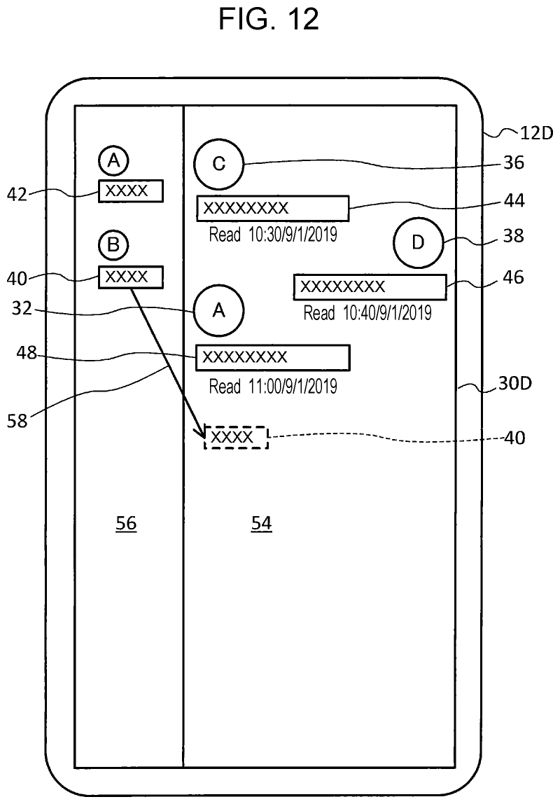

For example, as illustrated in FIG. 12, when the user D performs an operation of moving the message 40 displayed on the second screen 56 from the second screen 56 to the first screen 54, the processor 28 of the terminal apparatus 12D displays the message 40 on the first screen 54. The movement operation may be performed by a touch operation on the screen 30D or may be performed in response to an instruction using sound. For example, in a case where the user D drags the message 40 from the second screen 56 to the first screen 54 by a touch operation as indicated by an arrow 58 and drops the message 40 within the first screen 54, the message 40 is displayed on the first screen 54. For example, the message 40 is displayed at a position designated by the user D within the first screen 54. As another example, as in the display example illustrated in any one of FIGS. 8 to 10, the message 40 is displayed on the first screen 54. That is, the message 40 is displayed at the position immediately before the message 46 of the user D, in chronological order, or at the last position in the chronological order.

In the above-described example, the user A sends a message. Also in a case where the user B, C, or D sends a message, the above-described process is performed and a target message is sent to a destination user.

Data other than a message may be sent to a destination user. Data other than a message is, for example, image data, music data, document data, video data, or any selective combination thereof. When data is posted to the chat group α, a thumbnail image associated with the data is displayed on the screen 30A. The thumbnail image is also displayed on the screens for the other users. With an operation similar to the operation of sending the message 42 to a destination user, a thumbnail image associated with target data to be sent and a destination user are designated. In response to an instruction to send the target data, the target data is sent to the terminal apparatus 12 of the destination user via the SNS server 10. The terminal apparatus 12 of the destination user receives the target data from the SNS server 10. In response to receipt of the target data, the processor 28 of the terminal apparatus 12 of the destination user displays a thumbnail image associated with the data on the screen for the user. For example, in a case where the target data is sent to the user D, a thumbnail image associated with the data is displayed on the screen 30D. In this case, as in the display example illustrated in any one of FIGS. 8 to 10, the thumbnail image is displayed on the screen 30D. That is, the thumbnail image is displayed at the position immediately before the message 46 of the user D, in chronological order, or at the last position in the chronological order.

The target data may be stored in a predetermined storage device. The predetermined storage device is, for example, a device such as a file server. For example, a storage region associated with the destination user is formed in the file server, the target data is sent to the file server, and the target data is stored in the storage region associated with the destination user. The destination user is capable of obtaining the data from the storage region associated with the destination user.

In the example illustrated in FIG. 6, the user A sends the message 42, which has been posted to the chat group α by the user A, to a user other than the user A. Alternatively, the user A may send a message posted to the chat group α by a user other than the user A to another user.

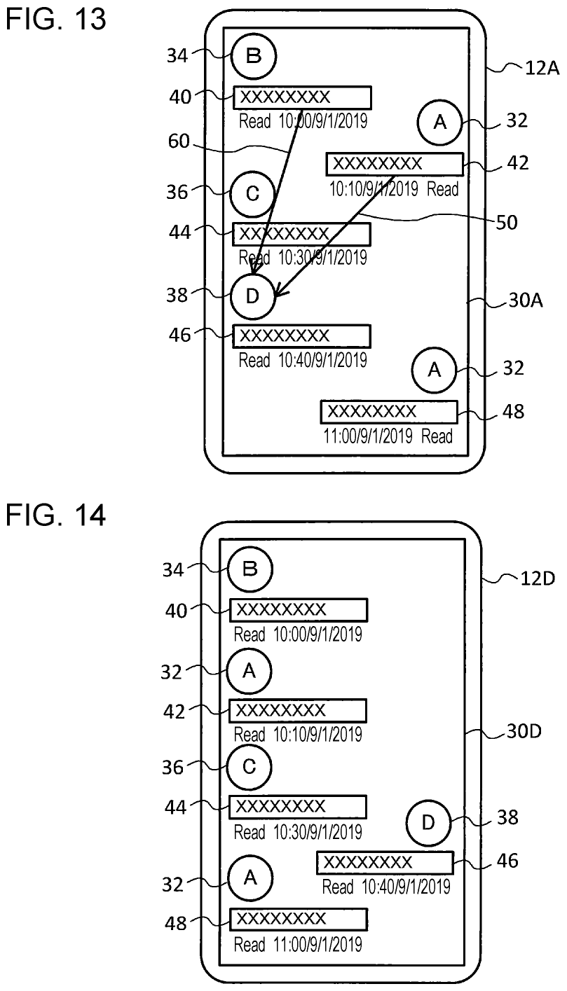

Hereinafter, a detailed description will be given of a process of sending a message of another user to a destination user, with reference to FIG. 13. FIG. 13 illustrates the screen 30A for the user A.

For example, when the user A moves the message 40 of the user B to the image 38 of the user D to superimpose the message 40 on the image 38, as indicated by an arrow 60, and provides a sending instruction, the processor 28 of the terminal apparatus 12A sends the message 40, the user identification information of the user D, and the group identification information of the chat group α to the SNS server 10. The processor 28 of the terminal apparatus 12A sends the user identification information of the user B who has posted the message 40 to the chat group α, the user identification information of the user A as a sending source who has provided an instruction to send the message 40 to the destination user D, or both the pieces of user identification information to the SNS server 10, together with the message 40, the user identification information of the user D, and the group identification information of the chat group α.

As in the above-described example, the target message 40 to be sent is sent to the terminal apparatus 12D of the user D via the SNS and displayed on the screen 30D for the user D. In this case, as in the display example illustrated in any one of FIGS. 8 to 10, the message 40 is displayed on the screen 30D. That is, the message 40 is displayed at the position immediately before the message 46 of the user D, in chronological order, or at the last position in the chronological order. As another example, the message 40 may be displayed on the second screen 56 as illustrated in FIG. 11.

The image 34 of the user B who has posted the message 40 to the chat group α may be displayed on the screen 30D in association with the message 40, the image 32 of the source user A may be displayed on the screen 30D in association with the message 40, or both the images 32 and 34 may be displayed on the screen 30D in association with the message 40.

A source user may send plural messages together to a destination user. For example, when the user A superimposes each of the messages 40 and 42 on the image 38 of the user D and then provides an instruction to send the messages 40 and 42 to the user D, the processor 28 of the terminal apparatus 12A sends the messages 40 and 42 together to the SNS server 10. For example, the user A superimposes the message 40 on the image 38 of the user D, then superimposes the massage 42 on the image 38 of the user D, and then presses a button image or the like for providing a sending instruction to provide an instruction to send the messages 40 and 42. The button image may be displayed on the screen 30A in advance, or may be hidden from the screen 30A and appear on the screen 30A when a target message to be sent is designated by the user A or when an operation of displaying the button image is performed by the user A. Of course, the message 40 may be sent to the user D when the message 40 is dragged to the image 38 and dropped on the image 38, and then the message 42 may be sent to the user D when the message 42 is dragged to the image 38 and dropped on the image 38. The messages 40 and 42 are sent to the terminal apparatus 12D of the user D via the SNS. The messages 40 and 42 are displayed on the screen 30D for the user D.

FIG. 14 illustrates the screen 30D after the messages 40 and 42 have been sent to the user D. In the example illustrated in FIG. 14, the messages 40 and 42 are displayed in chronological order in accordance with the dates and times at which the messages were posted. Of course, the messages 40 and 42 may be displayed on the screen 30D in a manner similar to the display example illustrated in any one of FIGS. 8 to 10. In addition, the image 34 of the user B who has posted the message 40 to the chat group is displayed on the screen 30D in association with the message 40. Similarly, the image 32 of the user A who has posted the message 42 to the chat group is displayed on the screen 30D in association with the message 42. Of course, the image 32 of the user A who has sent the message 40 to the user D may be displayed on the screen 30D in association with the message 40.

An image of a user associated with a target message to be sent may be designated by a source user or may be predetermined. For example, in a case where the user A provides an instruction to display the image of a source user when sending the target message 40 to the user D, the image 32 of the user A is displayed on the screen 30D in association with the message 40. In a case where the user A provides an instruction to display the image of the user who has posted the message 40 to the chat group α, the image 34 of the user B is displayed on the screen 30D in association with the message 40. In a case where the user A provides an instruction to display both the image of a source user and the image of the user who has posted the message 40 to the chat group α, the image 32 of the user A and the image 34 of the user B are displayed on the screen 30D in association with the message 40.

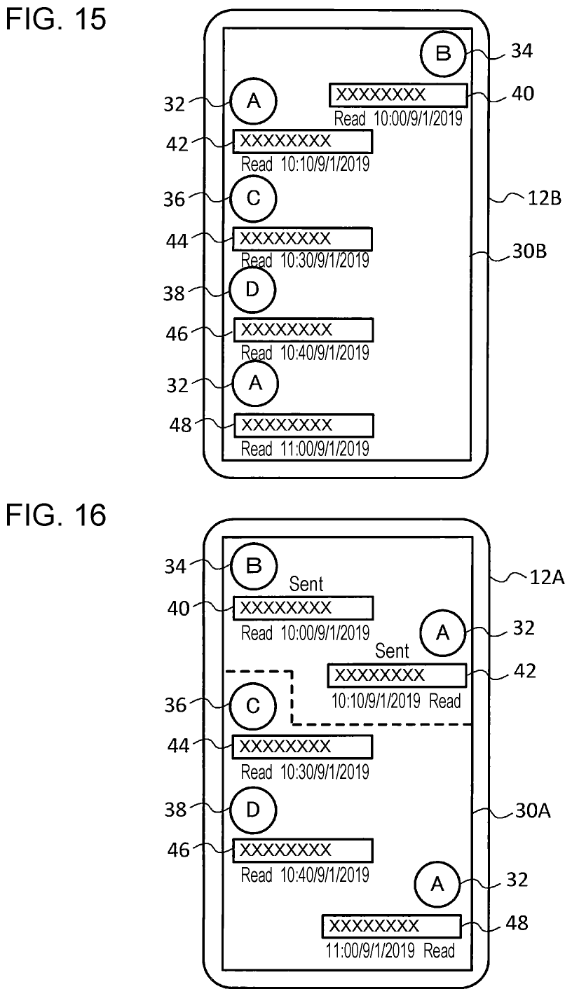

The messages 40 and 42 are sent to the user D, and are not sent to the other users belonging to the chat group α. For example, as illustrated in FIG. 15, on the screen 30B for the user B, the messages posted to the chat group α are displayed, and the messages 40 and 42 sent to the user D are not additionally displayed. On the screen 30B for the user B, a message posted by the user B is displayed in a right-side region, and messages posted by the other users are displayed in a left-side region.

A user may be prohibited from sending a message posted to the chat group α by someone other than the user to another user. For example, in a case where the user A provides an instruction to send a message posted to the chat group α by a user other than the user A (for example, the user B, C, or D) to another user, the processor 28 of the terminal apparatus 12A of the user A may not receive the instruction, or may receive the instruction and not send the target message designated by the user A to the SNS server 10. When the target message is not sent to the SNS server 10, the target message is not sent to a destination user designated by the user A. The processor 28 of the terminal apparatus 12A of the user A may send the target message designated by the user A to the SNS server 10, and the SNS server 10 may not send the target message to the destination user.

For example, for each message, whether or not to publish the message is set. A message that has been set to be published is a message that is permitted to be sent by a user other than a user who has posted the message to the chat group α to another user in the SNS. A message that has been set not to be published is a message that is prohibited from being sent by a user other than a user who has posted the message to the chat group α to another user in the SNS. Setting of whether or not to publish a message is performed by a user who has posted the message to the chat group α. In a case where setting of whether or not to publish a message is performed for each message, each user sets whether or not to publish a message posted by himself/herself. Alternatively, when a message is posted, whether or not to publish the message may be automatically set, and the setting may be changed by the user who has posted the message.

Whether or not to publish a message posted by a user may be set for each user. The setting is performed by the user. Whether or not to publish a message may be automatically set, and the user may change the setting. For example, when a message of the user A is set not to be published, users other than the user A are prohibited from sending the message of the user A to another user.

For each message, a sending destination to which the message is to be sent may be limited. For example, for each message, a destination to which the message is to be published or a destination to which the message is not to be published is set. The destination to which the message is to be published is a sending destination to which the message is permitted to be sent. The destination to which the message is not to be published is a sending destination to which the message is prohibited from being sent. For example, in a case where the users B and C are designated as destinations to which the message 42 of the user A is to be published, a user other than the user A is permitted to send the message 42 to the users B and C and is prohibited from sending the message 42 to the user D. The same applies to the case where the user D is designated as a destination to which the message 42 of the user A is not to be published. For example, a destination to which a message is to be published or a destination to which a message is not to be published may be set by a user who has posted the message to the chat group α. When a message is posted, a destination to which the message is to be published or a destination to which the message is not to be published may be automatically set, and the setting may be changed by the user who has posted the message.

A sending destination may be limited for each user. For example, a destination to which a message is to be published or a destination to which a message is not to be published is set for each user. For example, in a case where the users B and C are designated as destinations to which the message of the user A is to be published, a user other than the user A is permitted to send the message of the user A to the users B and C and is prohibited from sending the message of the user A to the user D. The same applies to the case where the user D is designated as a destination to which the message of the user A is not to be published.

An upper limit of the number of times of sending a message may be set. In this case, sending a message beyond the upper limit number is prohibited. The prohibition may be performed by the processor 20 of the SNS server 10 or by the processor 28 of the terminal apparatus 12 of the user who is going to send a message.

A message sent to a destination user may be stored separately from a message posted to the chat group α. For example, the message is stored in the storage device 26 of the terminal apparatus 12 of a source user who has sent the message. For example, in a case where the user A sends the messages 40 and 42 to the user D, the processor 28 of the terminal apparatus 12A stores the messages 40 and 42 in the storage device 26 of the terminal apparatus 12A separately from a message posted to the chat group α. In this way, a message sent to a destination user is stored. In addition, information indicating the dates and times at which the messages 40 and 42 were posted to the chat group α is stored. The user A may send all the stored messages 40 and 42 or a message selected from among the messages 40 and 42 by the user A to a user belonging to the chat group α. As a result of storing sent messages in this way, the stored messages may be used again. The messages sent by the user A are displayed on the screen for the destination user. At this time, the sent messages are displayed in chronological order in accordance with the dates and times at which the messages were posted.

In a case where a message posted to the chat group α has already been sent to a destination user, the processor 28 of the terminal apparatus 12 may display information indicating that fact on the screen for the user in association with the message. This process will be described with reference to FIG. 16. FIG. 16 illustrates the screen 30A for the user A. For example, the messages 40 and 42 have been sent to a user belonging to the chat group α. In this case, the processor 28 of the terminal apparatus 12A displays information indicating that the message 40 has bene sent (for example, a character string “sent” or a mark “sent”) on the screen 30A in association with the message 40. The same applies to the message 42.

For example, when the user B provides an instruction to send the message 40 to a destination user belonging to the chat group α, the message 40 is sent to the terminal apparatus 12 of the destination user via the SNS server 10. The processor 20 of the SNS server 10 sends, to the terminal apparatuses 12 of the individual users belonging to the chat group α, information indicating that the message 40 has been sent to the destination user belonging to the chat group α. In response to receipt of the information, the processor 28 of the terminal apparatus 12A of the user A displays information indicating that the message 40 has been sent on the screen 30A in association with the message 40. The same applies to the terminal apparatus 12C of the user C and the terminal apparatus 12D of the user D. The processor 28 of the terminal apparatus 12B of the user B displays information indicating that the message 40 has been sent on the screen 30B in association with the message 40. In the terminal apparatus 12 of the destination user of the message 40, information indicating that the message 40 has been sent may not be displayed in association with the message 40. A similar process is performed also in a case where the message 42 has been sent to a destination user belonging to the chat group α. As a result of information indicating that a message has been sent being displayed, the user is capable of recognizing that the message has bene sent.

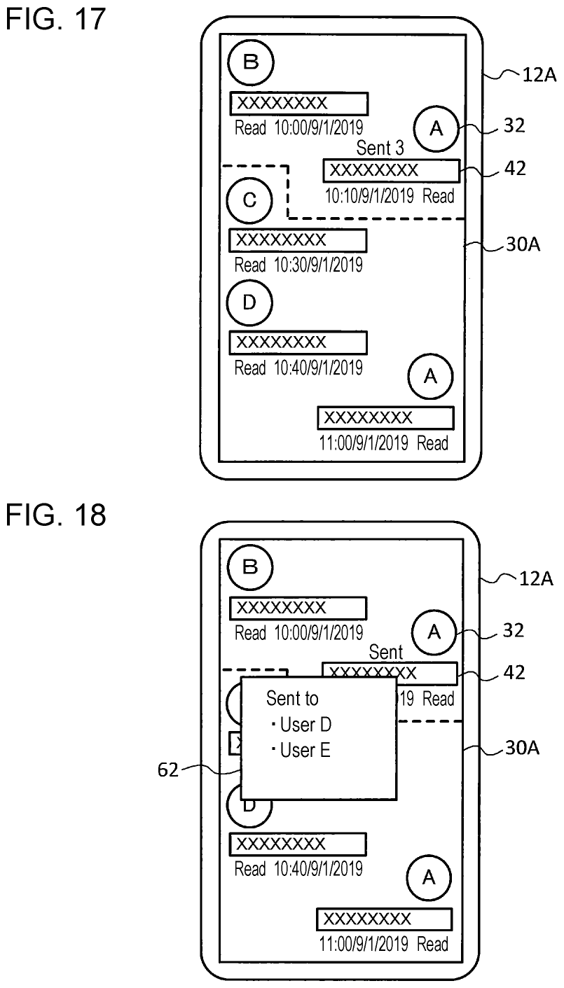

The processor 28 of the terminal apparatus 12 may display information indicating the number of times a message has been sent to a destination user belonging to the chat group α or information indicating the number of destination users to which a message has been sent, on the screen for the user in association with the message. FIG. 17 illustrates a display example of this case. For example, a character string “Sent 3” is displayed on the screen 30A in association with the message 42. This character string indicates that the message 42 has been sent three times or that the message 42 has been sent to three users. As described above, the processor 20 of the SNS server 10 sends information indicating that a target message has been sent to a destination user belonging to the chat group α to the terminal apparatuses 12 of the individual users belonging to the chat group α. The processors 28 of the terminal apparatuses 12 receive the information and thereby count, for each message, the number of times the message has been sent or the number of users to which the message has been sent. The counted number is displayed on the screen 30A.

In a case where a message is designated by the user A on the screen 30A, the processor 28 of the terminal apparatus 12A may display attribute information of the designated message on the screen 30A. The attribute information is, for example, information indicating a list of destination users of the message, the number of times the message has been sent to a destination user, the number of users to which the message has been sent, or the like. FIG. 18 illustrates a display example of the information. For example, in a case where the user A designates the message 42 on the screen 30A, the processor 28 of the terminal apparatus 12A displays a window 62 within the screen 30A. Attribute information of the message 42 is displayed within the window 62. Here, as an example, a list of destination users of the message 42 is displayed within the window 62. As described above, the processor 20 of the SNS server 10 sends, to the terminal apparatuses 12 of the individual users belonging to the chat group α, information indicating that a target message has been sent to a destination user belonging to the chat group α. The information includes information for identifying the target message and user identification information of the destination user. In response to receipt of the information indicating that the target message has been sent, the processor 28 of the terminal apparatus 12 specifies the sent message and the destination user of the message on the basis of the information, and includes the user identification information of the specified destination user in the attribute information of the specified message. For example, the message 42 has been sent to the users D and E, and the attribute information of the message 42 includes the pieces of user identification information of the users D and E. Accordingly, when the message 42 is designated, information indicating the destination users D and E of the message 42 is displayed within the window 62. For example, when the user A performs a touch operation on the message 42 on the screen 30A, the window 62 may be displayed. Alternatively, when the message 42 is clicked by using a mouse, the window 62 may be displayed.

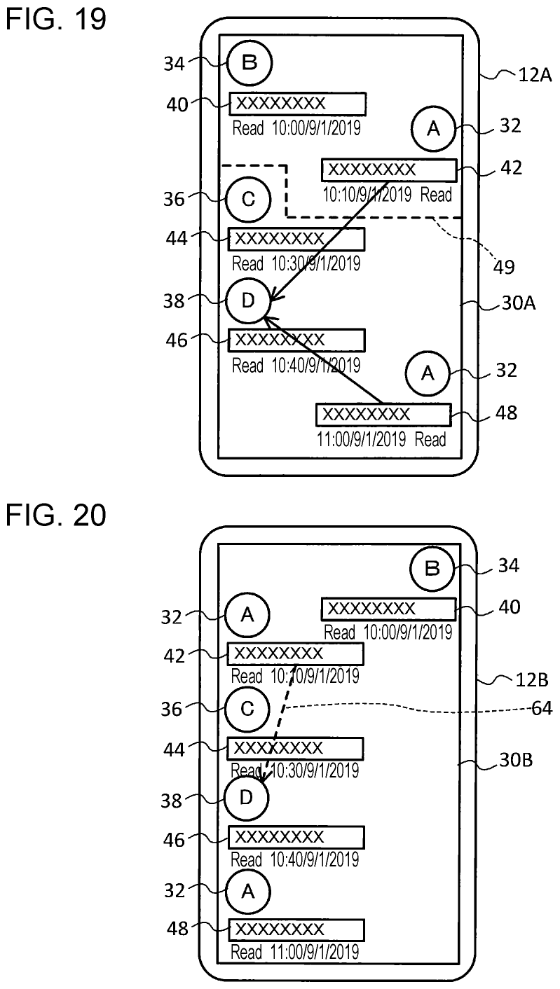

A past message and a newly posted message may be sent to a destination user. The past message is a message posted to a chat group before the destination user starts belonging to the chat group. The newly posted message is a message posted to a chat group after the destination user has started belonging to the chat group. This process will be described with reference to FIG. 19. FIG. 19 illustrates the screen 30A for the user A. For example, the user A may send to the user D the message 42 posted before the user D starts belonging to the chat group α, or may send to the user D the message 48 posted after the user D has started belonging to the chat group α. The message 48 is a message posted after the user D has started belonging to the chat group α, and thus the message 48 has already been sent to the user D. However, the message 48 is sent to the user D again if the user A sends the message 48 to the user D. Accordingly, the two messages 48 are displayed on the screen 30D for the user D. Of course, in a case where plural identical messages are sent, only one of the plural messages may be displayed. For example, one message 48 may be displayed on the screen 30D for the user D.

When a message posted to a chat group is to be sent to a destination user belonging to the chat group, a user other than a source user who is about to send the message may be notified that the message is to be sent to the destination user. The notification may be made by the processor 20 of the SNS server 10 or the processor 28 of the terminal apparatus 12.

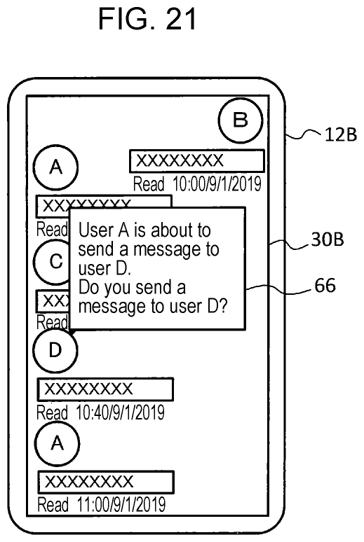

A process related to the above-described notification will be described with reference to FIGS. 20 and 21. FIGS. 20 and 21 illustrate the screen 30B for the user B.

For example, it is assumed that the user A is about to send the message 42 of the user A to the user D by superimposing the message 42 of the user A on the image 38 of the user D. More specifically, it is assumed that the user A has moved the message 42 to the image 38 of the user D but has not yet provided an instruction to send the message 42. For example, the user A has dragged the message 42 to the image 38 of the user D but has not yet dropped the message 42. After the user A has moved the message 42 to the image 38 of the user D, the processor 28 of the terminal apparatus 12A of the user A sends to the SNS server 10 information indicating that the user A is about to send the message 42 to the user D. The processor 20 of the SNS server 10 sends the information to the users B, C, and D belonging to the chat group α. In response to receipt of the information from the SNS server 10, the terminal apparatus 12B of the user B displays the information on the screen 30B for the user B. For example, as illustrated in FIG. 20, the processor 28 of the terminal apparatus 12B displays an arrow image 64 on the screen 30B. The arrow image 64 is an image indicating that the message 42 has been moved to the image 38 of the user D. The information indicating the position to which the message 42 has been moved is sent from the terminal apparatus 12A of the user A to the terminal apparatus 12B via the SNS. On the basis of the information, the processor 28 of the terminal apparatus 12B specifies the position to which the message 42 has been moved, and displays the arrow image 64 indicating the position on the screen 30B. In the example illustrated in FIG. 20, the position to which the message 42 has been moved is the position of the image 38 associated with the message 46 of the user D, and information indicating that the message 42 has been moved to the image 38 associated with the message 46 of the user D is sent to the terminal apparatus 12B. The processor 28 of the terminal apparatus 12B displays the arrow image 64 indicating the image 38 associated with the message 46 on the screen 30B.

In addition, as illustrated in FIG. 21, the processor 28 of the terminal apparatus 12B displays a message 66 on the screen 30B. The message 66 indicates that the user A is about to send a message to the user D and asks the user B whether the user B is to send a message to the user D. With reference to the message 66, the user B is capable of recognizing that the user A is about to send a message to the user D and is capable of sending a message to the user D.

In the embodiment above, the term “processor” refers to hardware in a broad sense. Examples of the processor include general processors (e.g., CPU: Central Processing Unit), and dedicated processors (e.g., GPU: Graphics Processing Unit, ASIC: Application Integrated Circuit, FPGA: Field Programmable Gate Array, and programmable logic device). In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
set a user account of a speaker belonging to a chat group,
cause a display device to display a display region for sharing content of a conversation held between a plurality of speakers belonging to the chat group,
receive at least a part of the conversation held between the plurality of speakers who have already joined the chat group before the speaker having the user account joins the chat group, and
display the at least a part of the conversation in the display region for the user account in an inserted manner.

2. The information processing apparatus according to claim 1, wherein the processor is configured to
display content of a conversation in the display region in chronological order, and
display the at least a part of the conversation in the display region such that the at least a part is inserted at a position immediately before a certain message of the speaker having the user account.

3. The information processing apparatus according to claim 1, wherein the processor is configured to
display the at least a part of the conversation in the display region such that the at least a part is inserted at a last position in chronological order in the display region for the user account.

4. The information processing apparatus according to claim 1, wherein the processor is configured to
receive data that is other than a message and that has been sent to the user account from a speaker included in the plurality of speakers other than the speaker having the user account.

5. The information processing apparatus according to claim 1, wherein data that is other than a message and that has been sent to the user account from a speaker included in the plurality of speakers other than the speaker having the user account is stored in a predetermined storage device.

6. The information processing apparatus according to claim 1, wherein a position at which the at least a part of the conversation is to be inserted in the display region is determined by the speaker having the user account or a speaker who has sent the at least a part of the conversion to the user account.

7. The information processing apparatus according to claim 1, wherein the processor is configured to
display, in the display region, in association with the at least a part of the conversation, speaker identification information for identifying a speaker who has sent the at least a part of the conversation to the user account.

8. The information processing apparatus according to claim 1, wherein the processor is configured to
display, in the display region, in association with the at least a part of the conversation, speaker identification information for identifying a speaker who has posted the at least a part of the conversation in the conversation held between the plurality of speakers.

9. The information processing apparatus according to claim 1, wherein
the display region includes a first display region and a second display region, and
the processor is configured to
display content of a conversation in the first display region in chronological order,
display the at least a part of the conversation in the second display region, and
in response to an operation of moving the at least a part of the conversation from the second display region to the first display region, display the at least a part of the conversation in the first display region.

10. An information processing apparatus comprising:
a processor configured to
cause a display device to display a display region for sharing content of a conversation held between a plurality of speakers belonging to a chat group, and
send at least a part of the conversation held between the plurality of speakers to another speaker having a user account other than the plurality of speakers.

11. The information processing apparatus according to claim 10, wherein the processor is configured to
in a case where the at least a part of the conversation has already been sent to the other speaker, display information indicating that the at least a part of the conversation has already been sent to the other speaker in the display region in association with the at least a part of the conversation.

12. The information processing apparatus according to claim 10, wherein the at least a part of the conversation includes a past message and a newly posted message.

13. The information processing apparatus according to claim 10, wherein the processor is configured to
send data different from a message to the other speaker.

14. The information processing apparatus according to claim 10, wherein the at least a part of the conversation includes a message posted in the conversation held between the plurality of speakers by a speaker who has sent the at least a part of the conversation to the other speaker.

15. The information processing apparatus according to claim 10, wherein the at least a part of the conversation includes a message posted in the conversation held between the plurality of speakers by a speaker other than a speaker who has sent the at least a part of the conversation to the other speaker.

16. The information processing apparatus according to claim 15, wherein the conversation held between the plurality of speakers includes a not-to-be-published message that has been set not to be published, the not-to-be-published message being prohibited from being sent to the other speaker by a speaker other than a speaker who has posted the not-to-be-published message in the conversation held between the plurality of speakers.

17. The information processing apparatus according to claim 10, wherein the at least a part of the conversation is stored as information that has been sent to the other speaker, while being distinguished from the conversation held between the plurality of speakers.

18. The information processing apparatus according to claim 10, wherein the processor is configured to
in response to designation of a message included in the conversation held between the plurality of speakers, cause the display device to display a list of the other speaker to which the designated message has been sent.

19. The information processing apparatus according to claim 10, wherein the processor is configured to
when the at least a part of the conversation is to be sent to the other speaker, ask a speaker other than a speaker who is to send the at least a part of the conversation to the other speaker whether to send a message to the other speaker.

20. An information processing system comprising:
a first information processing apparatus; and
a second information processing apparatus,
the first information processing apparatus including a first processor configured to
cause a first display device to display a first display region for sharing content of a conversation held between a plurality of speakers belonging to a chat group, and
send at least a part of the conversation held between the plurality of speakers to another speaker having a user account other than the plurality of speakers,
the second information processing apparatus including a second processor configured to
cause a second display device to display a second display region for sharing the content of the conversation held between the plurality of speakers,
receive the at least a part of the conversation sent to the other speaker, and
display the at least a part of the conversation in the second display region.

21. A non-transitory computer readable medium storing a program causing a computer to execute a process, the process comprising:
setting a user account of a speaker belonging to a chat group;
causing a display device to display a display region for sharing content of a conversation held between a plurality of speakers belonging to the chat group;
receiving at least a part of the conversation held between the plurality of speakers who have already joined the chat group before the speaker having the user account joins the chat group; and
displaying the at least a part of the conversation in the display region for the user account in an inserted manner.

22. A non-transitory computer readable medium storing a program causing a computer to execute a process, the process comprising:
causing a display device to display a display region for sharing content of a conversation held between a plurality of speakers belonging to a chat group, and
sending at least a part of the conversation held between the plurality of speakers to another speaker having a user account other than the plurality of speakers.
